(19) United States
(12) Patent Application Publication
(10) Pub. No.: US 2013/0051067 A1
(43) Pub. Date: Feb. 28, 2013

(54) Backlight Module with Connecting Circuits

(71) Applicant: Tsan-Jung Chen, New Taipei City (TW)

(72) Inventor: Tsan-Jung Chen, New Taipei City (TW)

(73) Assignee: KOCAM INTERNATIONAL CO., LTD., New Taipei City (TW)

(21) Appl. No.: 13/220,681

(22) Filed: Aug. 30, 2011

(51) Int. Cl. F21V 7/04

(52) U.S. Cl. 362/607; 362/606; 362/612

(57) ABSTRACT

The present invention relates to a backlight module with connecting circuits, comprising: at least one main circuit lay, a first connecting circuit layer and a second connecting circuit layer, wherein the first connecting circuit layer and the second connecting circuit layer can be connected with the main circuit layer by way of a second time welding process, therefore the total circuit area of the backlight module is increased. Moreover, in the backlight module with connecting circuits, a plurality of first holes are form on a housing, and the first holes sink from the outer surface to the inner surface of the housing bottom, such that each of the LED chips are snugly covered by the inner walls of the first holes when they respectively enter the first holes; Therefore, when the LED chips emit the light, the heat produced by each of the surfaces of the LED chips can be rapidly conducted to the housing via the inner walls of the first holes, and then the heat may be dissipated through the housing.

### BACKGROUND OF THE INVENTION

1. Technical Field

The present invention relates to a backlight module, and more particularly, to a backlight module with connecting circuits, wherein the connecting circuits are connected to each other by way of welding process.

2. Description of Related Art

Recently, light-emitting diode (LED) is widely applied in illumination apparatuses. Because LED would get very hot when it is emitting, a conventional LED illumination apparatus commonly includes radiation materials or heat-dissipating device.

Please refer to FIG. 1, which illustrates a stereo view of a conventional LED device. As shown in FIG. 1, the conventional LED device 10′ includes: a substrate 101′ and a plastic body 102′, wherein at least one LED chip is disposed on the surface of the substrate 101′; moreover, opposite of the LED chip, a plurality of metal pins are disposed on the another surface of the substrate 101′. The plurality of metal pins includes: two positive electrodes 1011′, two negative electrodes 1012′ and one de-soldering electrode 1013′.

Continuously referring to FIG. 1, and simultaneously referring to FIG. 2, which illustrates a stereo diagram of a conventional LED backlight module. As shown in FIG. 2, the conventional LED backlight module 1′ is installed in a main frame of a liquid crystal display device, used for providing a backlight to a light guide plate (not shown in FIGs.). The conventional LED backlight module 1′ includes: a housing 11′, a printed circuit board 12′ and a plurality of LED devices 10′. The LED devices 10′ are mounted on the printed circuit board 12′, moreover, the printed circuit board 12′ and the LED devices 10′ are accommodated by the housing 11″. In addition, an electronic circuit is printed on the printed circuit board 12′, wherein the electronic circuit has a plurality of welding points for soldering the LED devices 10′.

The aforesaid LED backlight module 1′ has two advantages: (1) simple structure; and (2) easy to be installed in the main frame. Thus, the LED backlight module 1′ is widely applied in various liquid crystal display devices for providing the backlight to the light guide plate. However, with the change in user habits, it is requested to be manufactured as a thin liquid crystal display device regardless of the large-sized liquid crystal display device or the small-sized liquid crystal display device. However, for the LED backlight module applied in the thin liquid crystal display device, it must face a great challenge, i.e., the complete and complex electronic circuit must be printed on a limit-sized printed circuit board.

Accordingly, for solving the great challenge, some backlight module manufactures propose the concept of folded printed circuit board, in which the complete electronic circuit is printed on a foldable printed circuit board, and then the foldable printed circuit board is folded and disposed in the housing; thus, the great challenge is solved. However, the concept of folded printed circuit board still has two shortcomings and drawbacks: (1) the foldable printed circuit board can not be steadily disposed and fixed in the housing; and (2) the foldable printed circuit board can not completely insulated from the LED device.

So that, in view of the conventional LED backlight module still has shortcomings and drawbacks, the inventor of the present application has made great efforts to make inventive research thereon and eventually provided a backlight module with connecting circuits.

### BRIEF SUMMARY OF THE INVENTION

The first objective of the present invention is to provide a backlight module with connecting circuits, in which, a first connecting circuit layer and a second connecting circuit layer can be connected with a main circuit layer by way of a second-time process for increasing the total circuit area of the backlight module.

Accordingly, to achieve the first objective of the present invention, the inventor proposes a backlight module with connecting circuits, comprising:
a housing, having at least one housing bottom, at least one housing long portion and at least one housing short portion, and a plurality of first holes are formed on the housing bottom;
a first thermally conductive insulating layer, disposed on the outer surface of the housing for covering the housing bottom, the housing long portion and the housing short portion, the first thermally conductive insulating layer has a plurality of second holes formed on the side thereof opposite to the housing bottom;
a substrate;
a main circuit layer, disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, attached to the first thermally conductive insulating layer by the inner surface thereof and located on the housing long portion, wherein the first connecting circuit layer has a plurality of first conductive lines, and the first conductive lines are extended to the housing bottom for connecting the main conductive lines of the main circuit layer;
a second connecting circuit layer, attached to the first thermally conductive insulating layer by the inner surface thereof and located on the housing short portion, wherein the second connecting circuit layer has a plurality of second conductive lines, and the second conductive lines are extended to the housing bottom for connecting the main conductive lines of the main circuit layer;
a plurality of LED chips, disposed on the main circuit layer and located on the metal pads, moreover, the LED chips respectively pass through the second holes and the first holes by a light-emitting surface thereof, so that the LED chips entering the housing;
a reflector, opposite to the LED chips and disposed in the housing, the reflector having a plurality of third holes for facilitating each of the light-emitting surfaces of the LED chips to pass through; and
a light guide plate, disposed in the reflector for receiving the light emitted from the third holes.

The second objective of the present invention is to provide a backlight module with connecting circuits, in which, a first connecting circuit layer and a second connecting circuit layer can be connected with a main circuit layer by way of a second-time process for increasing the total circuit area of the backlight module; Moreover, a plurality of first holes are formed on a housing of the backlight module, and the first holes sink from the outer surface from the inner surface of the housing bottom, such that each of the LED chips are snugly covered by the inner walls of the first holes when they respectively enter the first holes; Thus, when the LED chips emit the light, the heat produced by each of the surfaces of the LED chips can be rapidly conducted to the housing via the inner walls of the first holes, and then the heat may be dissipated through the housing.

In order to achieve the second objective of the present invention, the inventor proposes a backlight module with connecting circuits, comprising:
a housing, having at least one housing bottom, at least one housing long portion and at least one housing short portion, and the housing bottom has a plurality of first holes sunk from the outer surface to the inner surface thereof;
a first thermally conductive insulating layer, disposed on the outer surface of the housing for covering the housing bottom, the housing long portion and the housing short portion, the first thermally conductive insulating layer has a plurality of second holes formed on the side thereof opposite to the housing bottom;
a substrate;
a main circuit layer, disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, attached to the first thermally conductive insulating layer by the inner surface thereof and located on the housing long portion, wherein the first connecting circuit layer has a plurality of first conductive lines, and the first conductive lines are extended to the housing bottom for connecting the main conductive lines of the main circuit layer;
a second connecting circuit layer, attached to the first thermally conductive insulating layer by the inner surface thereof and located on the housing short portion, wherein the second connecting circuit layer has a plurality of second conductive lines, and the second conductive lines are extended to the housing bottom for connecting the main conductive lines of the main circuit layer;
a plurality of LED chips, disposed on the main circuit layer and located on the metal pads, moreover, the LED chips respectively pass through the second holes and the first holes by a light-emitting surface thereof, so that each of the LED chips enter the housing and are snugly covered by the inner walls of the first holes, respectively;
a reflector, opposite to the LED chips and disposed in the housing, the reflector has a plurality of third holes for facilitating each of the light-emitting surfaces of the LED chips to pass through; and
a light guide plate, disposed in the reflector for receiving the light emitted from the third holes;
wherein when the LED chips emit the light, the heat produced by each of the surfaces of the LED chips can be rapidly conducted to the housing via the inner walls of the first holes, and then the heat may be dissipated through the housing.

The third objective of the present invention is to provide a backlight module with connecting circuits, in which, a hosing accommodating the LED chips, the reflector and the light guide plate is disposed in an extrusion housing, such that the backlight module with connecting circuits of the present invention can be applied in the LCD display of the portable electronic products; Moreover, a first connecting circuit layer and a second connecting circuit layer can be connected with a main circuit layer by way of a second-time process for increasing the total circuit area of the backlight module.

Thus, for achieving the third objective of the present invention, the inventor proposes a backlight module with connecting circuits, comprising:
an extrusion housing, having at least one bottom portion and a bearing portion formed on the bottom portion;
a housing, disposed on the bearing portion of the extrusion housing and having at least one housing bottom, at least one housing long portion and at least one housing short portion, moreover, a plurality of first holes are formed on the housing bottom;
a first thermally conductive insulating layer, disposed on the outer surface of the housing for covering the housing bottom, the housing long portion and the housing short portion, the first thermally conductive insulating layer has a plurality of second holes formed on the side thereof opposite to the housing bottom;
a substrate;
a main circuit layer, disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, attached to the first thermally conductive insulating layer by the inner surface thereof and located on the housing long portion, wherein the first connecting circuit layer has a plurality of first conductive lines, and the first conductive lines are extended to the housing bottom for connecting the main conductive lines of the main circuit layer;
a second connecting circuit layer, attached to the first thermally conductive insulating layer by the inner surface thereof and located on the housing short portion, wherein the second connecting circuit layer has a plurality of second conductive lines, and the second conductive lines are extended to the housing bottom for connecting the main conductive lines of the main circuit layer;
a plurality of LED chips, disposed on the main circuit layer and located on the metal pads, moreover, the LED chips respectively pass through the second holes and the first holes by a light-emitting surface thereof, so that the LED chips enter the housing;
a reflector, opposite to the LED chips and disposed in the housing, the reflector has a plurality of third holes for facilitating each of the light-emitting surfaces of the LED chips to pass through; and
a light guide plate, disposed in the reflector for receiving the light emitted from the third holes.

The fourth objective of the present invention is to provide a backlight module with connecting circuits, in which, a housing accommodating the LED chips, the reflector and the light guide plate is disposed in an extrusion housing, such that the backlight module with connecting circuits of the present invention can be applied in the LCD display of the portable electronic products; Besides, a first connecting circuit layer and a second connecting circuit layer can be connected with a main circuit layer by way of a second-time process for increasing the total circuit area of the backlight module; Moreover, a plurality of first holes are formed on a housing of the backlight module, and the first holes sink from the outer surface from the inner surface of the housing bottom, such that each of the LED chips are snugly covered by the inner walls of the first holes when they respectively enter the first holes; Thus, when the LED chips emit the light, the heat produced by each of the surfaces of the LED chips can be rapidly conducted to the housing via the inner walls of the first holes, and then the heat may be dissipated through the housing.

Accordingly, to achieve the fourth objective of the present invention, the inventor proposes a backlight module with connecting circuits, comprising: an extrusion housing, having at least one bottom portion and a bearing portion formed on the bottom portion;
a housing, disposed on the bearing portion of the extrusion housing and having at least one housing bottom, at least one housing long portion and at least one housing short portion, moreover, a plurality of first holes are formed on the housing bottom and the plurality of first holes sink from the outer surface to the inner surface of the housing bottom;
a first thermally conductive insulating layer, disposed on the outer surface of the housing for covering the housing bottom, the housing long portion and the housing short portion, the first thermally conductive insulating layer has a plurality of second holes formed on the side thereof opposite to the housing bottom;
a substrate;
a main circuit layer, disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, attached to the first thermally conductive insulating layer by the inner surface thereof and located on the housing long portion, wherein the first connecting circuit layer has a plurality of first conductive lines, and the first conductive lines are extended to the housing bottom for connecting the main conductive lines of the main circuit layer;
a second connecting circuit layer, attached to the first thermally conductive insulating layer by the inner surface thereof and located on the housing short portion, wherein the second connecting circuit layer has a plurality of second conductive lines, and the second conductive lines are extended to the housing bottom for connecting the main conductive lines of the main circuit layer;
a plurality of LED chips, disposed on the main circuit layer and located on the metal pads, moreover, the LED chips respectively pass through the second holes and the first holes by a light-emitting surface thereof, so that each of the LED chips enter the housing and are snugly covered by the inner walls of the first holes, respectively;
a reflector, opposite to the LED chips and disposed in the housing, the reflector has a plurality of third holes for facilitating each of the light-emitting surfaces of the LED chips to pass through; and
a light guide plate, disposed in the reflector for receiving the light emitted from the third holes;
wherein when the LED chips emit the light, the heat produced by each of the surfaces of the

LED chips can be rapidly conducted to the housing via the inner walls of the first holes, and then the heat may be dissipated through the housing.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo view of a conventional LED device.

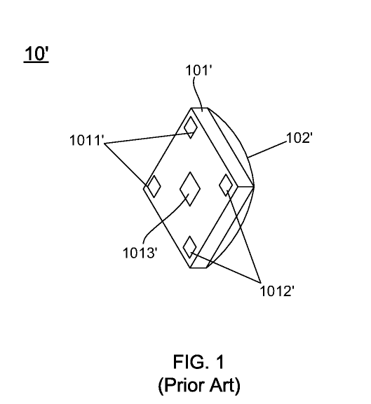

FIG. 2 is a stereo diagram of a conventional LED backlight module;

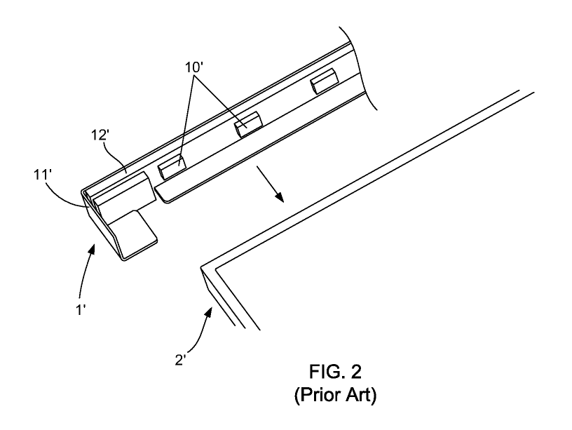

FIG. 3 is a side view of a first embodiment of a backlight module with connecting circuits according to the present invention;

FIG. 4 is a stereo view of the first embodiment of the backlight module with connecting circuits according to the present invention;

FIG. 5 is a second side view of the first embodiment of the backlight module with connecting circuits;

FIG. 6 is a side view of a second embodiment of the backlight module with connecting circuits according to the present invention;

FIG. 7 is a stereo view of the second embodiment of the backlight module with connecting circuits according to the present invention;

FIG. 8 is a second side view of the second embodiment of the backlight module with connecting circuits;

FIG. 9 is a side view of a third embodiment of the backlight module with connecting circuits according to the present invention;

FIG. 10 is a stereo view of the third embodiment of the backlight module with connecting circuits according to the present invention;

FIG. 11 is a second side view of the third embodiment of the backlight module with connecting circuits;

FIG. 12 is a side view of a fourth embodiment of the backlight module with connecting circuits according to the present invention;

FIG. 13 is a stereo view of the fourth embodiment of the backlight module with connecting circuits according to the present invention; and

FIG. 14 is a second side view of the fourth embodiment of the backlight module with connecting circuits.

### DETAILED DESCRIPTION OF THE INVENTION

To more clearly describe a backlight module with connecting circuits according to the present invention, embodiments of the present invention will be described in detail with reference to the attached drawings hereinafter.

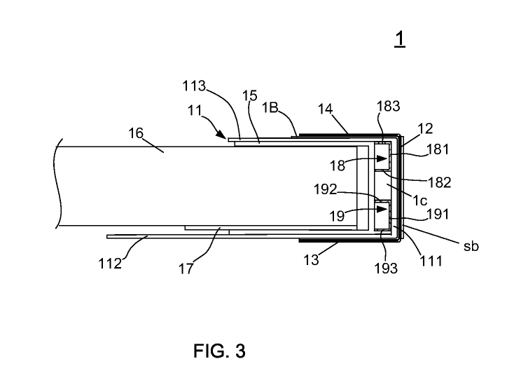

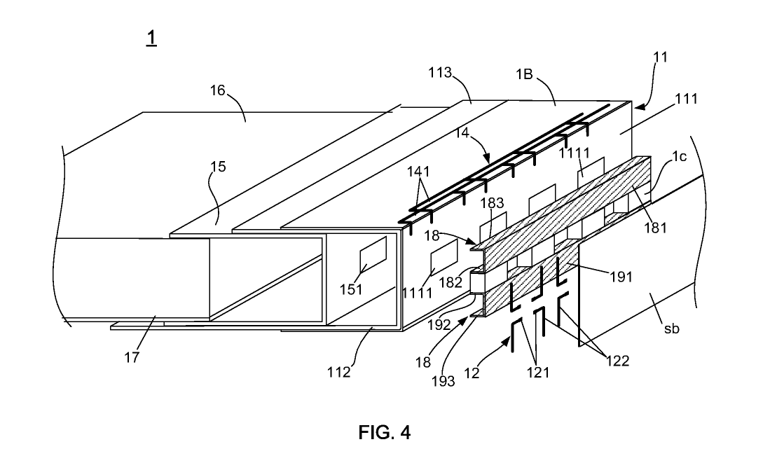

The present invention includes multi embodiments for introducing the backlight module with connecting circuits. Please refer to FIG. 3 and FIG. 4, there are shown a side view and a stereo view of a first embodiment of the backlight module with connecting circuits according to the present invention. As shown in FIG. 3 and FIG. 4, the first embodiment of the backlight module 1 with connecting circuits includes: a housing 11, a first thermally conductive insulating layer 1B, a substrate sb, a main circuit layer 12, a first connecting circuit layer 13, a second connecting circuit layer 14, a plurality of LED chips 1C, a reflector 15, a light guide plate 16, a bottom reflector 17, a first shaped thermal conductive layer 18, and a second shaped thermal conductive layer 19.

The housing 11 can be made by a metal, a high reflectivity polyester film, a plastic, or a fiberglass. It must determine that the LED chips 1C accommodated by the housing 11 is high power LED chips or low power LED chips when choosing the manufacturing material of the housing 11. Therefore, it must use the metal as the manufacturing material of the housing 11 if the housing 11 is configured for accommodating the high power LED chips. In the first embodiment of the backlight module 1, the housing 11 includes a housing bottom 112, a housing long portion 112 and a housing short portion 113, and a plurality of first holes (not shown) are formed on the housing bottom 111. The first thermally conductive insulating layer 1B is disposed on the outer surface of the housing 11 for covering the housing bottom 111, the housing long portion 112 and the housing short portion 113, the first thermally conductive insulating layer 1B includes a plurality of second holes 1111 formed on the side thereof opposite to the housing bottom 111.

Continuously referring to FIG. 3 and FIG. 4, the main circuit layer 12 is disposed on the substrate sb through a second thermally conductive insulating layer (not shown) and has a plurality of metal pads 121 and a plurality of main conductive lines 122 connecting to the metal pads 121, wherein the main circuit layer 12 and the substrate sb are attached to the first thermally conductive insulating layer 1B and located on the outer surface of housing bottom 111. Moreover, with the difference of manufacturing materials of the housing 11, the substrate sb and the main circuit layer 12 are made by using different materials. For example, when the housing 11 is made by the metal material with better thermal conductivity, the substrate sb and the main circuit layer 12 may be also fabricated by using the metal material with better thermal conductivity, for instance, copper; However, the main circuit layer 12 is formed on the surface of the substrate sb (fiberglass) if the housing 11 is made by non-metal material (i.e., the high reflectivity polyester film, the plastic, or the fiberglass).

The first connecting circuit layer 13 is attached to the first thermally conductive insulating layer 1B by the inner surface thereof and located on the housing long portion 112, wherein the first connecting circuit layer 13 has a plurality of first conductive lines, and the first conductive lines are extended to the housing bottom 111 for connecting the main conductive lines 122 of the main circuit layer 12. The second connecting circuit layer 14 is opposite to the first connecting circuit layer 13 and attached to the first thermally conductive insulating layer 1B by the inner surface thereof; in addition, the second connecting circuit layer 14 is located on the housing short portion 113. The second connecting circuit layer 14 has a plurality of second conductive lines 141, and the second conductive lines 141 are extended to the housing bottom 111 for connecting the main conductive lines 122 of the main circuit layer 12.

The LED chips 1C are disposed on the main circuit layer 12 and welded to the metal pads 121 by way of a first-time welding process, moreover, the LED chips 1C respectively pass through the second holes 1111 and the first holes by a light-emitting surface thereof, so that the LED chips 1C enter the housing 11. Herein, it has to further explain that, the first connecting circuit layer 13 and the second connecting circuit layer 14 are connected to the main circuit layer 12 through a second-time welding process after the LED chips 1C are welded to the main circuit layer 12. The reflector 15 is opposite to the LED chips 1C and disposed in the housing 11, wherein the reflector 15 has a plurality of third holes 151 for facilitating each of the light-emitting surfaces of the LED chips 1C to pass through. The light guide plate 16 is disposed in the reflector 15 for receiving the light emitted from the third holes 151. The bottom reflector 17 is disposed on the bottom of the light guide plate 16 for preventing from the light leakage.

The first shaped thermal conductive layer 18 is disposed in the housing 11 and has a first bottom 181, a first side portion 182 and a second side portion 183, wherein when the first shaped thermal conductive layer 18 is disposed in the housing 11, the first shaped thermal conductive layer 18 is attached to the housing bottom 111 by the first bottom 181 thereof, and the first side portion 182 and the second side portion 183 of the first shaped thermal conductive layer 18 are attached to each of one side surfaces of the LED chips 1C and the housing short portion 113, respectively. Opposite to the first shaped thermal conductive layer 18, the second shaped thermal conductive layer 19 is disposed in the housing and has a second bottom 191, a third side portion 192 and a fourth side portion 193. When the first shaped thermal conductive layer 19 is disposed in the housing 11, the second shaped thermal conductive layer 19 is attached to the housing bottom 111 by the second bottom 191 thereof, and the third side portion 192 and the fourth side portion 193 of the second shaped thermal conductive layer 19 are attached to each of another one side surfaces of the LED chips 1C and the housing long portion 112, respectively.

So that, through above descriptions, the first embodiment of the backlight module 1 with connecting circuits of the present invention has been completely introduced, and in summary, the aforesaid backlight module 1 with connecting circuits includes the features and the advantages as follows:
1. By way of disposing the first shaped thermal conductive layer 18 and the second shaped thermal conductive layer 19 in the housing 11, the heat produced by the LED chips 1C can be transmitted to the housing 11 through the first shaped thermal conductive layer 18 and the second shaped thermal conductive layer 19, and the heat would be dissipated via the housing 11.
2. The total circuit area of the backlight module 1 is increased by way of connecting the first connecting circuit layer 13 and the second connecting circuit layer 14 with the main circuit layer 12 by way of the second-time process; Therefore, large circuit area provide a flexible design space for the backlight module manufacturer when they design the circuits of the LED chips 1C.

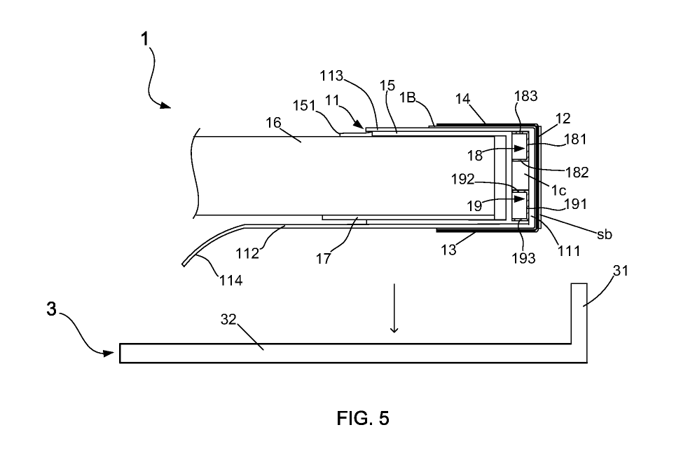

Moreover, it can also add some structure features into the framework of the first embodiment of the backlight module with connecting circuits for increasing the efficiency thereof Please refer to FIG. 5, which illustrates a second side view of the first embodiment of the backlight module with connecting circuits. As shown in FIG. 5, when fabricating the backlight module 1 with connecting circuits, the end of the housing long portion 112 can be formed a housing tassel 114 if the housing 11 is made of the metal material, so that, when the backlight module 1 is installed into a main frame 3 with at least one edge 31 and a bottom plate 32, the housing tassel 114 of the housing long portion 112 can be completely and compactly attached to the bottom plate 32 of the main frame 3; therefore, the heat dissipated from the housing 11 may be conducted to the far-end of the bottom plate 32 via the housing tassel 114, such that bottom plate 32 gets a uniform surface temperature.

Furthermore, the end of the reflector 15 can be formed a reflector tassel 151, wherein when the light guide plate 16 accommodated by the reflector 15, the reflector tassel 151 can be completely and compactly attached to the top surface of the light guide plate 16 for preventing from the light leakage occurring at the gap between the light guide plate 16 and the reflector 15. Finally, for increasing the heat-dissipation efficiency of the backlight module 1 with the connecting circuits, it is able to coat a heat radiative material, such as an nanodiamond, on the outer surface of the first connecting circuit layer 13 and the second connecting circuit layer 14 after the first connecting circuit layer 13 and the second connecting circuit layer 14 are disposed on the outer surface of the housing long portion 112 and the housing short portion 113.

Besides, for the aforesaid first embodiment of the backlight module 1 with connecting circuits, it must further explain that, if the housing 11 is made of the non-metal material and the substrate sb is made of the FR4 fiberglass when fabricating the backlight module 1, such that the first thermally conductive insulating layer 1B can be removed since the substrate sb does not be insulated from the housing 11.

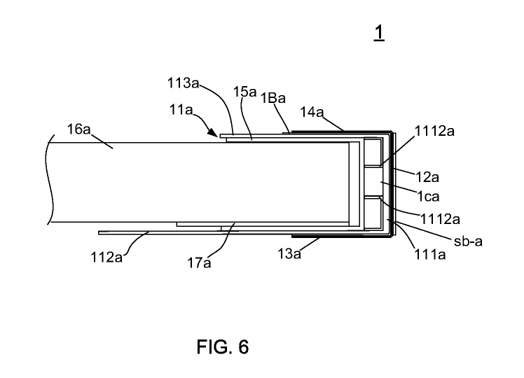

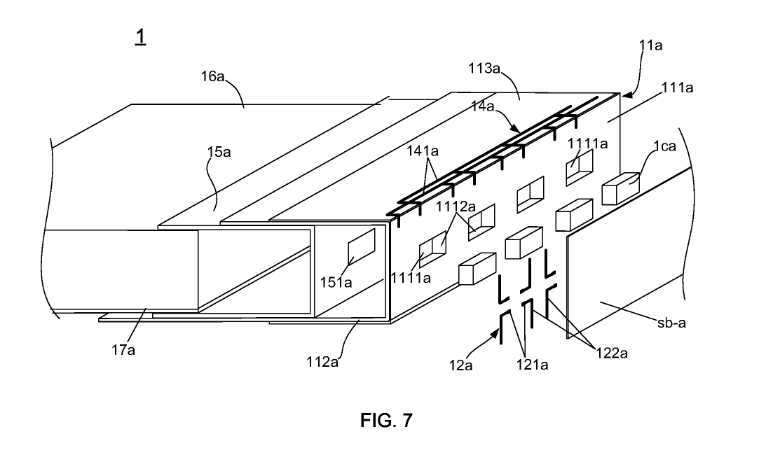

The present invention also includes a second embodiment for the backlight module with connecting circuits. Please refer to FIG. 6 and FIG. 7, there are shown a side view and a stereo view of the second embodiment of the backlight module with connecting circuits according to the present invention. As shown in FIG. 6 and FIG. 7, the second embodiment of the backlight module 1 includes: a housing 11a, a first thermally conductive insulating layer 1Ba, a substrate sb-a, a main circuit layer 12a, a first connecting circuit layer 13a, a second connecting circuit layer 14a, a plurality of LED chips 1Ca, a reflector 15a, a light guide plate 16a, and a bottom reflector 17a.

The housing 11a includes a housing bottom 111a, a housing long portion 112a and a housing short portion 113a, wherein the housing bottom 111a has a plurality of first holes 1111a sunk from the outer surface to the inner surface thereof. The first thermally conductive insulating layer 1Ba is disposed on the outer surface of the housing 11a for covering the housing bottom 111a, the housing long portion 112a and the housing short portion 113a, besides, the first thermally conductive insulating layer 1Ba includes a plurality of second holes (not shown) formed on the side thereof opposite to the housing bottom 111a.

Continuously referring to FIG. 6 and FIG. 7, The main circuit layer 12a is disposed on the substrate sb-a through a second thermally conductive insulating layer (not shown) and has a plurality of metal pads 121a and a plurality of main conductive lines 122a connecting to the metal pads 121a, wherein the main circuit layer 12a and the substrate sb-a are attached to the first thermally conductive insulating layer 1Ba and located on the outer surface of housing bottom 111a. The first connecting circuit layer 13a is attached to the first thermally conductive insulating layer 1Ba by the inner surface thereof and located on the housing long portion 112a, wherein the first connecting circuit layer 13a includes a plurality of first conductive lines, and the first conductive lines are extended to the housing bottom 111a for connecting the main conductive lines 122a of the main circuit layer 12a. Opposite of the first connecting circuit layer 13a, the second connecting circuit layer 14a is attached to the first thermally conductive insulating layer 1Ba by the inner surface thereof and located on the housing short portion 113a. The second connecting circuit layer includes a plurality of second conductive lines 141a, and the second conductive lines 141a are extended to the housing bottom 111a for connecting the main conductive lines 122a of the main circuit layer 12a.

The plurality of LED chips 1Ca are disposed on the main circuit layer 12a and welded on the metal pads 121a by way of a first-time welding process. The LED chips 1Ca respectively pass through the second holes and the first holes 1111a by a light-emitting surface thereof, so that each of the LED chips 1Ca enter the housing 11a and are snugly covered by the inner walls 1112a of the first holes 1111a, respectively. Similar to aforesaid first embodiment, in the second embodiment of the backlight module with connecting circuits, the first connecting circuit layer 13a and the second connecting circuit layer 14a are connected to the main circuit layer 12a through a second-time welding process after the LED chips 1Ca are welded on the main circuit layer 12a.

The reflector 15a is opposite to the LED chips 1Ca and disposed in the housing 11a, wherein the reflector 15a includes a plurality of third holes 151a for facilitating each of the light-emitting surfaces of the LED chips 1Ca to pass through. The light guide plate 16a is disposed in the reflector 15a for receiving the light emitted from the third holes 151a. However, different from the aforesaid first embodiment, in the second embodiment of the backlight module 1 with connecting circuits, the heat produced by each of the surfaces of the LED chips 1Ca are rapidly conducted to the housing 11a via the inner walls 1112a of the first holes 1111a, and the heat is dissipated through the housing 11a.

Thus, through above descriptions, the second embodiment of the backlight module 1 with connecting circuits of the present invention has been completely introduced, and in summary, the second embodiment of the backlight module 1 with connecting circuits includes the features and the advantages as follows:
1. By way of disposing the plurality of first holes 111a sunk from the outer surface to the inner surface of the housing bottom 111a, when the LED chips 1Ca emit the light, the heat produced by each of the surfaces of the LED chips 1Ca can be rapidly conducted to the housing 11a via the inner walls 1112a of the first holes 1111a, and then the heat may be dissipated through the housing 11a.
2. The total circuit area of the backlight module 1 is increased by way of connecting the first connecting circuit layer 13a and the second connecting circuit layer 14a with the main circuit layer 12a by way of the second-time process; Therefore, large circuit area provide a flexible design space for the backlight module manufacturer when they design the circuits of the LED chips 1Ca.

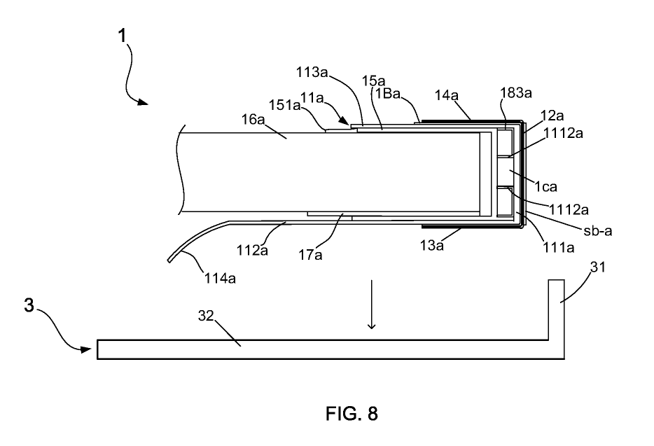

Moreover, the same to the aforesaid first embodiment, it can also add some structure features into the framework of the second embodiment of the backlight module with connecting circuits for increasing the efficiency thereof. Please refer to FIG. 8, which illustrates a second side view of the second embodiment of the backlight module with connecting circuits. As shown in FIG. 8, when fabricating the backlight module 1 with connecting circuits, the end of the housing long portion 112a can be formed a housing tassel 114a if the housing 11a is made of the metal material, so that, when the backlight module 1 is installed into a main frame 3 with at least one edge 31 and a bottom plate 32, the housing tassel 114a of the housing long portion 112a can be completely and compactly attached to the bottom plate 32 of the main frame 3; therefore, the heat dissipated from the housing 11a may be conducted to the far-end of the bottom plate 32 via the housing tassel 114a, such that bottom plate 32 gets a uniform surface temperature.

Furthermore, the end of the reflector 15a can be formed a reflector tassel 151a, wherein when the light guide plate 16a accommodated by the reflector 15a, the reflector tassel 151a can be completely and compactly attached to the top surface of the light guide plate 16a for preventing from the light leakage occurring at the gap between the light guide plate 16a and the reflector 15a. Eventually, for increasing the heat-dissipation efficiency of the backlight module 1 with the connecting circuits, it is able to coat a heat radiative material, such as an nanodiamond, on the outer surface of the first connecting circuit layer 13a and the second connecting circuit layer 14a after the first connecting circuit layer 13a and the second connecting circuit layer 14a are disposed on the outer surface of the housing long portion 112a and the housing short portion 113a.

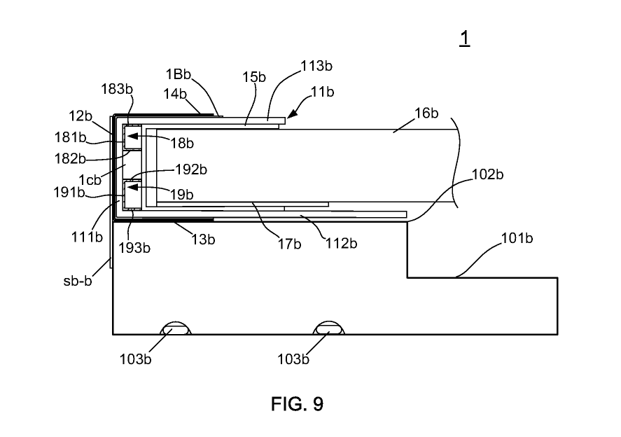

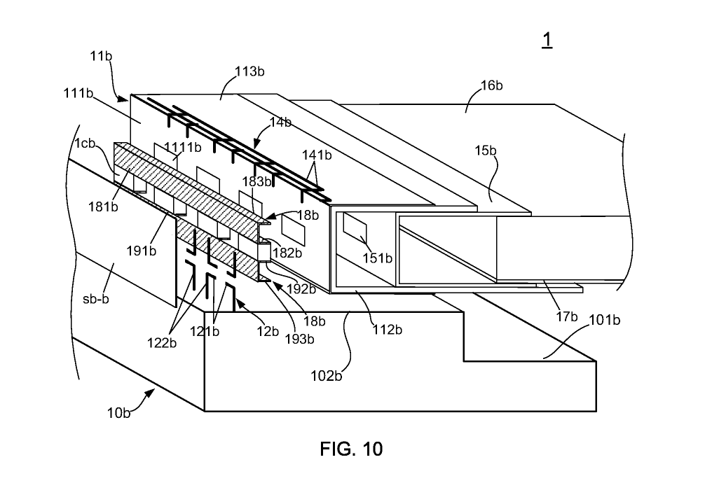

In order to make the backlight module with connecting circuits capable of being applied in the portable electronic products, the present invention further provides a third embodiment for the backlight module with connecting circuits. Please refer to FIG. 9 and FIG. 10, there are shown a side view and a stereo view of the third embodiment of the backlight module with connecting circuits according to the present invention. As shown in FIG. 9 and FIG. 10, the third embodiment of the backlight module 1 with connecting circuits includes: an extrusion housing 10b, a housing 11b, a first thermally conductive insulating layer 1Bb, a substrate sb-b, a main circuit layer 12b, a first connecting circuit layer 13b, a second connecting circuit layer 14b, a plurality of LED chips 1Cb, a reflector 15b, a light guide plate 16b, a bottom reflector 17b, a first shaped thermal conductive layer 18b, and a second shaped thermal conductive layer 19b.

The manufacturing material of the extrusion housing 10b can be copper, aluminum, galvanized steel sheet, or hot-dip galvanized steel sheet. The extrusion housing 10b includes a bottom portion 101b and a bearing portion 102b formed on the bottom portion 101b. The housing 11b is disposed on the bearing portion 102b of the extrusion housing 10b, and the manufacturing material of the housing 11b can be the metal, the high reflectivity polyester film, the plastic, or the fiberglass. In which, it must determine that the LED chips 1Cb accommodated by the housing 11b is high power LED chips or low power LED chips when choosing the manufacturing material of the housing 11b. Therefore, it must use the metal as the manufacturing material of the housing 11b if the housing 11b is configured for accommodating the high power LED chips. In the third embodiment of the backlight module 1, the housing 11b includes a housing bottom 112b, a housing long portion 112b and a housing short portion 113b; in addition, a plurality of first holes (not shown) are formed on the housing bottom 111b.

Continuously referring to FIG. 9 and FIG. 10, the first thermally conductive insulating layer 1B is disposed on the outer surface of the housing 1 1b for covering the housing bottom 111b, the housing long portion 112b and the housing short portion 113b, wherein the first thermally conductive insulating layer 1B has a plurality of second holes 1111b formed on the side thereof opposite to the housing bottom 111b. The main circuit layer 12b is disposed on the substrate sb-b through a second thermally conductive insulating layer (not shown) and includes a plurality of metal pads 121b and a plurality of main conductive lines 122b connecting to the metal pads 121b. The main circuit layer 12b and the substrate sb-b are attached to the first thermally conductive insulating layer 1Bb and located on the outer surface of housing bottom 111b. Herein, it must to note that, with the difference of manufacturing materials of the housing 11b, the substrate sb-b is made by using different materials. For example, when the housing 11b is made by the metal material with better thermal conductivity, the substrate sb-b may be also fabricated by using the metal material with better thermal conductivity, for instance, aluminum. However, the main circuit layer 12b is formed on the surface of a fiberglass substrate sb-b if the housing 11b is made by non-metal material (i.e., the high reflectivity polyester film, the plastic, or the fiberglass). Moreover, the substrate further has a combination device (not show) for combining with the extrusion housing 10b.

The first connecting circuit layer 13b is attached to the first thermally conductive insulating layer 1Bb by the inner surface thereof and located on the housing long portion 112b, wherein the first connecting circuit layer 13b includes a plurality of first conductive lines, and the first conductive lines are extended to the housing bottom 111b for connecting the main conductive lines 122b of the main circuit layer 12b. Opposite of the first connecting circuit layer 13b, the second connecting circuit layer 14b is attached to the first thermally conductive insulating layer 1Bb by the inner surface thereof and located on the housing short portion 113b. The second connecting circuit layer 14b has a plurality of second conductive lines 141b, and the second conductive lines 141b are extended to the housing bottom 111b for connecting the main conductive lines 122b of the main circuit layer 12b.

The plurality of LED chips 1Cb are disposed on the main circuit layer 12b and welded on the metal pads 121b by way of a first-time welding process, moreover, the LED chips 1Cb respectively pass through the second holes and the first holes 1111b by a light-emitting surface thereof, so that the LED chips 1Cb enter the housing 11b. Herein, it has to further explain that, the first connecting circuit layer 13b and the second connecting circuit layer 14b are connected to the main circuit layer 12b through a second-time welding process after the LED chips 1Cb are welded to the main circuit layer 12b. In addition, the reflector 15b is opposite to the LED chips 1Cb and disposed in the housing 11b, wherein the reflector 15b has a plurality of third holes 151b for facilitating each of the light-emitting surfaces of the LED chips 1Cb to pass through. The light guide plate 16b is disposed in the reflector 15b for receiving the light emitted from the third holes 151b. The bottom reflector 17b is disposed on the bottom of the light guide plate 16b for preventing from the light leakage.

The first shaped thermal conductive layer 18b is disposed in the housing 11b and includes a first bottom 181b, a first side portion 182b and a second side portion 183b. When the first shaped thermal conductive layer 18b is disposed in the housing 11b, the first shaped thermal conductive layer 18b is attached to the housing bottom 111b by the first bottom 181b thereof, and the first side portion 181b and the second side portion 182b of the first shaped thermal conductive layer 18b are attached to each of one side surfaces of the LED chips 1Cb and the housing short portion 113b, respectively. Opposite of the first shaped thermal conductive layer 18b, the second shaped thermal conductive layer 19b is disposed in the housing 11b and includes a second bottom 191b, a third side portion 192b and a fourth side portion 193b. In which, when the first shaped thermal conductive layer 19b is disposed in the housing 11b, the second shaped thermal conductive layer 19b is attached to the housing bottom 111b by the second bottom 191b thereof, and the third side portion 192b and the fourth side portion 193b of the second shaped thermal conductive layer 19b are attached to each of another one side surfaces of the LED chips 1Cb and the housing long portion 112b, respectively.

Therefore, through above descriptions, the first embodiment of the backlight module 1 with connecting circuits of the present invention has been completely introduced, and in summary, the aforesaid backlight module 1 with connecting circuits includes the features and the advantages as follows:
1. The same to aforesaid first embodiment, in the third embodiment of the backlight module 1 with connecting circuits, it disposes the first shaped thermal conductive layer 18b and the second shaped thermal conductive layer 19b in the housing 11b, such that the heat produced by the LED chips 1Cb can be transmitted to the housing 11b through the first shaped thermal conductive layer 18b and the second shaped thermal conductive layer 19b, and then the heat would be dissipated via the housing 11b.
2. Moreover, the total circuit area of the backlight module 1 is increased by way of connecting the first connecting circuit layer 13b and the second connecting circuit layer 14b with the main circuit layer 12b by way of the second-time process; Therefore, large circuit area provide a flexible design space for the backlight module manufacturer when they design the circuits of the LED chips 1Cb.
3. Furthermore, different from the aforesaid first embodiment, in the third embodiment of the backlight module 1 with connecting circuits, an extrusion housing 10b is used for accommodating the housing 11b having the LED chips 1Cb, wherein the extrusion housing 10b is able to effectively protect the LED chips 1Cb from damage when the backlight module 1 is hit by an external force.

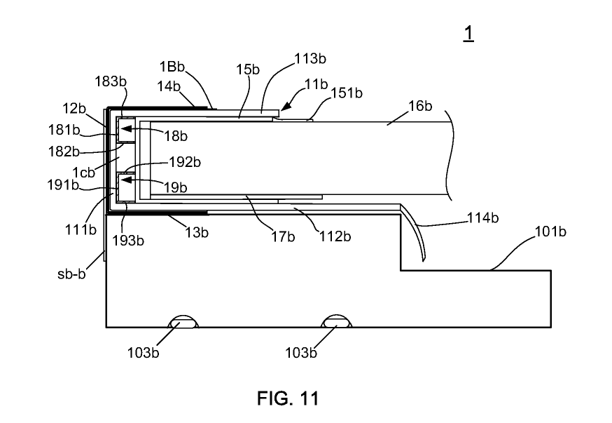

Please refer to FIG. 11, which illustrates a second side view of the third embodiment of the backlight module with connecting circuits. As shown in FIG. 11, it is the same to the aforesaid first embodiment that some structure features can be added into the framework of the second embodiment of the backlight module with connecting circuits for increasing the efficiency thereof. When fabricating the backlight module 1 with connecting circuits, the end of the housing long portion 112b can be formed a housing tassel 114b if the housing 11b is made of the metal material, so that, when the backlight module 1 is installed into a main frame 3 with at least one edge 31 and a bottom plate 32, the housing tassel 114b of the housing long portion 112b can be completely and compactly attached to the bottom plate 32 of the main frame 3; therefore, the heat dissipated from the housing 11b may be conducted to the far-end of the bottom plate 32 via the housing tassel 114b, such that bottom plate 32 gets a uniform surface temperature. Besides, the end of the reflector 15b can be formed a reflector tassel 151b; therefore, when the light guide plate 16b accommodated by the reflector 15b, the reflector tassel 151b can be completely and compactly attached to the top surface of the light guide plate 16b for preventing from the light leakage occurring at the gap between the light guide plate 16b and the reflector 15b. Furthermore, for increasing the heat-dissipation efficiency of the backlight module 1 with the connecting circuits, it is able to coat a heat radiative material, such as an nanodiamond, on the outer surface of the first connecting circuit layer 13b and the second connecting circuit layer 14b after the first connecting circuit layer 13b and the second connecting circuit layer 14b are disposed on the outer surface of the housing long portion 112b and the housing short portion 113b. Or, disposing a heat-conductive foam on the outer surface of the bottom portion 101b of the extrusion housing 10b for increasing the heat-dissipation efficiency.

Besides, for the aforesaid third embodiment of the backlight module 1 with connecting circuits, it must further explain that, if the housing 11b is made of the non-metal material and the substrate sb-b is made of the FR4 fiberglass when fabricating the backlight module 1, such that the first thermally conductive insulating layer 1B can be removed since the substrate sb-b does not be insulated from the housing 11b.

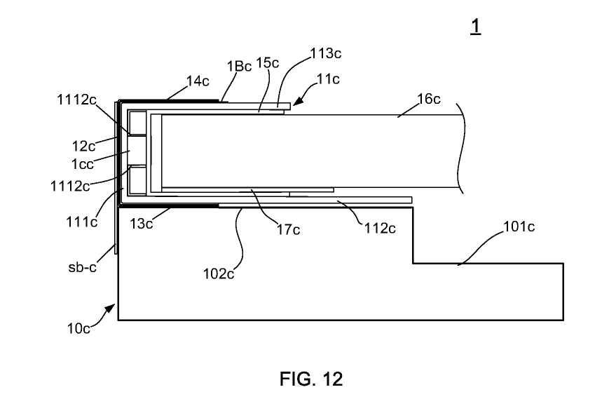

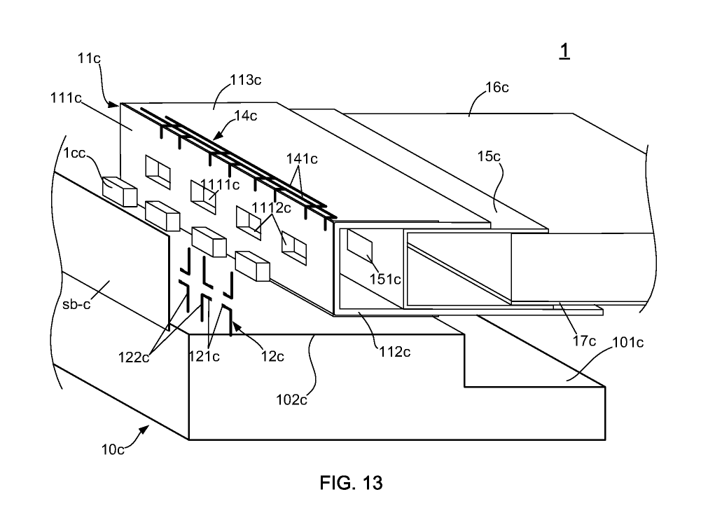

Finally, the present invention includes a fourth embodiment for the backlight module with connecting circuits. Please refer to FIG. 12 and FIG. 13, there are shown a side view and a stereo view of the fourth embodiment of the backlight module with connecting circuits according to the present invention. As shown in FIG. 12 and FIG. 13, the fourth embodiment of the backlight module 1 with connecting circuits includes: an extrusion housing 10c, a housing 11c, a first thermally conductive insulating layer 1Bc, a substrate sb-c, a main circuit layer 12c, a first connecting circuit layer 13c, a second connecting circuit layer 14c, a plurality of LED chips 1Cc, a reflector 15c, a light guide plate 16c, and a bottom reflector 17c.

The extrusion housing 10c has a bottom portion 101c and a bearing portion 102c formed on the bottom portion 101c. The housing 11c is disposed on the bearing portion 102c of the extrusion housing 10c and includes a housing bottom 111c, a housing long portion 112c and a housing short portion 113c, moreover, a plurality of first holes 1111c are formed on the housing bottom 111c and the plurality of first holes 1111c sink from the outer surface to the inner surface of housing bottom 111c. The first thermally conductive insulating layer 1Bc is disposed on the outer surface of the housing 11c for covering the housing bottom 111c, the housing long portion 112c and the housing short portion 113c, wherein the first thermally conductive insulating layer 1Bc includes a plurality of second holes (not shown) formed on the side thereof opposite to the housing bottom 111c.

Continuously referring to FIG. 12 and FIG. 13, the main circuit layer 12c is disposed on the substrate sb-c through a second thermally conductive insulating layer (not shown) and has a plurality of metal pads 121c and a plurality of main conductive lines 122c connecting to the metal pads 121c. The main circuit layer 12c and the substrate sb-c are attached to the first thermally conductive insulating layer 1Bc and located on the outer surface of housing bottom 111c. The first connecting circuit layer 13c is attached to the first thermally conductive insulating layer 1Bc by the inner surface thereof and located on the housing long portion 112c, wherein the first connecting circuit layer 13c includes a plurality of first conductive lines, and the first conductive lines are extended to the housing bottom 111c for connecting the main conductive lines 122c of the main circuit layer 12c. Opposite of the first connecting circuit layer 13c, the second connecting circuit layer 14c is attached to the first thermally conductive insulating layer 1Bc by the inner surface thereof and located on the housing short portion 113c. The second connecting circuit layer 14c includes a plurality of second conductive lines 141c, and the second conductive lines 141c are extended to the housing bottom 111c for connecting the main conductive lines 122c of the main circuit layer 12c. Moreover, the substrate sb-c has a combination device (not shown) for combining with the extrusion housing 10c.

The plurality of LED chips 1Cc are disposed on the main circuit layer 12c and welded on the metal pads 121c by way of a first-time welding process, moreover, the LED chips 1Cc respectively pass through the second holes and the first holes 1111c by a light-emitting surface thereof, so that each of the LED chips 1Cc enter the housing 11c and are snugly covered by the inner walls 1112c of the first holes 1111c, respectively. Similarly, the first connecting circuit layer 13c and the second connecting circuit layer 14c are connected to the main circuit layer 12c through a second-time welding process after the LED chips 1Cc are welded on the main circuit layer 12c.

The reflector 15c is opposite to the LED chips 1Cc and disposed in the housing 11c, wherein the reflector 15c includes a plurality of third holes 151c for facilitating each of the light-emitting surfaces of the LED chips 1Cc to pass through. The light guide plate 16c is disposed in the reflector 15c for receiving the light emitted from the third holes 151c. Different from the aforesaid third embodiment, in the fourth embodiment of the backlight module 1, when the LED chips 1Cc emit the light, the heat produced by each of the surfaces of the LED chips 1Cc can be rapidly conducted to the housing 11c via the inner walls 1112c of the first holes 1111c, and then the heat may be dissipated through the housing 11c. Beside, the bottom reflector 17c, which is disposed on the bottom of the light guide plate 16c for preventing from the light leakage.

Thus, through above descriptions, the fourth embodiment of the backlight module 1 with connecting circuits of the present invention has been completely introduced, and in summary, the fourth embodiment of the backlight module 1 with connecting circuits includes the features and the advantages as follows:
1. The same to the aforesaid second embodiment, in the fourth embodiment of the backlight module 1 with connecting circuits, it disposes the plurality of first holes 111c sunk from the outer surface to the inner surface of the housing bottom 111c, such that the heat produced by each of the surfaces of the LED chips 1Cc can be rapidly conducted to the housing 11c via the inner walls 1112c of the first holes 1111c, and then the heat may be dissipated through the housing 11c.
2. Moreover, the total circuit area of the backlight module 1 is increased by way of connecting the first connecting circuit layer 13c and the second connecting circuit layer 14c with the main circuit layer 12c through the second-time process; Therefore, large circuit area provide a flexible design space for the backlight module manufacturer when they design the circuits of the LED chips 1Cc.
3. Furthermore, different from the aforesaid second embodiment, in the fourth embodiment of the backlight module 1 with connecting circuits, an extrusion housing 10c is used for accommodating the housing 11c having the LED chips 1Cc, wherein the extrusion housing 10c is able to effectively protect the LED chips 1Cc from damage when the backlight module 1 is hit by an external force.

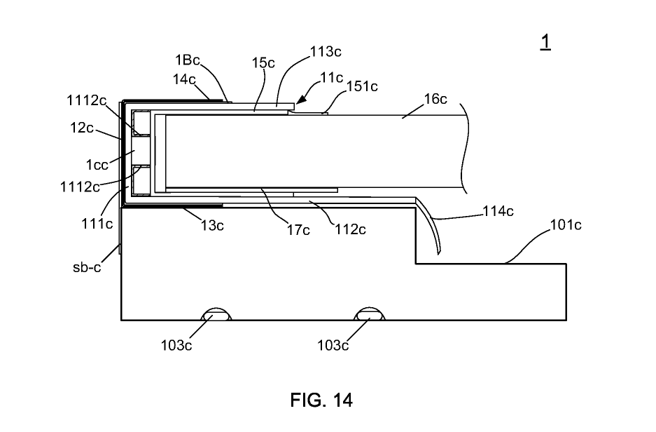

Please sequentially refer to FIG. 14, which illustrates a second side view of the fourth embodiment of the backlight module with connecting circuits. As shown in FIG. 14, it is the same to the aforesaid second embodiment that some structure features can be added into the framework of the fourth embodiment of the backlight module with connecting circuits for increasing the efficiency thereof. When fabricating the backlight module 1 with connecting circuits, the end of the housing long portion 112c can be formed a housing tassel 114c if the housing 11c is made of the metal material, so that, when the backlight module 1 is installed into a main frame 3 with at least one edge 31 and a bottom plate 32, the housing tassel 114c of the housing long portion 112c can be completely and compactly attached to the bottom plate 32 of the main frame 3; therefore, the heat dissipated from the housing 11c may be conducted to the far-end of the bottom plate 32 via the housing tassel 114c, such that bottom plate 32 gets a uniform surface temperature. Besides, the end of the reflector 15c can be formed a reflector tassel 151c; therefore, when the light guide plate 16c accommodated by the reflector 15c, the reflector tassel 151c can be completely and compactly attached to the top surface of the light guide plate 16c for preventing from the light leakage occurring at the gap between the light guide plate 16c and the reflector 15c. Furthermore, for increasing the heat-dissipation efficiency of the backlight module 1 with the connecting circuits, it is able to coat a heat radiative material, such as an nanodiamond, on the outer surface of the first connecting circuit layer 13c and the second connecting circuit layer 14c after the first connecting circuit layer 13c and the second connecting circuit layer 14c are disposed on the outer surface of the housing long portion 112c and the housing short portion 113c. Or, disposing a heat-conductive foam on the outer surface of the bottom portion 101c of the extrusion housing 10c for increasing the heat-dissipation efficiency.

Therefore, the above descriptions have been clearly and completely introduced all practical embodiments of the backlight module with connecting circuits according to the present invention. However, the above description is made on embodiments of the present invention. However, the embodiments are not intended to limit scope of the present invention, and all equivalent implementations or alterations within the spirit of the present invention still fall within the scope of the present invention.

I claim:

1. A backlight module with connecting circuits, comprising:
a housing, having at least one housing bottom, at least one housing long portion and at least one housing short portion, and a plurality of first holes being formed on the housing bottom;
a first thermally conductive insulating layer, being disposed on the outer surface of the housing for covering the housing bottom, the housing long portion and the housing short portion, the first thermally conductive insulating layer having a plurality of second holes formed on the side thereof opposite to the housing bottom;
a substrate;
a main circuit layer, being disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, being attached to the first thermally conductive insulating layer by the inner surface thereof and located on the housing long portion, wherein the first connecting circuit layer has a plurality of first conductive lines, and the first conductive lines being extended to the housing bottom for connecting the main conductive lines of the main circuit layer;
a second connecting circuit layer, being attached to the first thermally conductive insulating layer by the inner surface thereof and located on the housing short portion, wherein the second connecting circuit layer has a plurality of second conductive lines, and the second conductive lines being extended to the housing bottom for connecting the main conductive lines of the main circuit layer;
a plurality of LED chips, being disposed on the main circuit layer and located on the metal pads, moreover, the LED chips respectively passing through the second holes and the first holes by a light-emitting surface thereof, so that the LED chips entering the housing;
a reflector, being opposite to the LED chips and disposed in the housing, the reflector having a plurality of third holes for facilitating each of the light-emitting surfaces of the LED chips to pass through; and
a light guide plate, being disposed in the reflector for receiving the light emitted from the third holes.

2. The backlight module with connecting circuits of claim 1, further comprising:
a bottom reflector, being disposed on the bottom of the light guide plate for preventing from the light leakage;
at least one first shaped thermal conductive layer, being disposed in the housing and having a first bottom, a first side portion and a second side portion, wherein when the first shaped thermal conductive layer is disposed in the housing, the first shaped thermal conductive layer being attached to the housing bottom by the first bottom thereof, and the first side portion and the second side portion of the first shaped thermal conductive layer being attached to each of one side surfaces of the LED chips and the housing short portion; and
at least one second shaped thermal conductive layer, being opposite to the first shaped thermal conductive layer and disposed in the housing and having a second bottom, a third side portion and a fourth side portion, wherein when the first shaped thermal conductive layer is disposed in the housing, the second shaped thermal conductive layer being attached to the housing bottom by the second bottom thereof, and the third side portion and the fourth side portion of the second shaped thermal conductive layer being attached to each of another one side surfaces of the LED chips and the housing long portion;
wherein when the LED chips emit the light, the heat produced by each of the surfaces of the LED chips can be rapidly conducted to the housing via the first shaped thermal conductive layer and the second shaped thermal conductive layer, and then the heat may be dissipated through the housing.

3. The backlight module with connecting circuits of claim 1, wherein LED chips are welded on the metal pads by way of a first-time welding process, and the first connecting circuit layer and the second connecting circuit layer being connected to the main circuit layer through a second-time welding process.

4. The backlight module with connecting circuits of claim 1, wherein manufacturing material of the housing is selected from the group consisting of: metal, high reflectivity polyester film, plastic, and fiberglass.

5. The backlight module with connecting circuits of claim 4, wherein when the housing is made by the metal material with thermal conductivity, the housing long portion is further formed a housing tassel on the end thereof.

6. The backlight module with connecting circuits of claim 1, wherein the manufacturing material of the substrate is selected from the group consisting of: metal and fiber glass.

7. The backlight module with connecting circuits of claim 1, wherein the end of the reflector is further formed a reflector tassel.

8. The backlight module with connecting circuits of claim 1, wherein a heat radiative material can be further coated on the outer surface of the first connecting circuit layer and the second connecting circuit layer after the first connecting circuit layer and the second connecting circuit layer are disposed on the outer surface of the housing long portion and the housing short portion.

9. A backlight module with connecting circuits, comprising:
a housing, having at least one housing bottom, at least one housing long portion and at least one housing short portion, and the housing bottom having a plurality of first holes sunk from the outer surface to the inner surface thereof;
a first thermally conductive insulating layer, being disposed on the outer surface of the housing for covering the housing bottom, the housing long portion and the housing short portion, the first thermally conductive insulating layer having a plurality of second holes formed on the side thereof opposite to the housing bottom;
a substrate;
a main circuit layer, being disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, being attached to the first thermally conductive insulating layer by the inner surface thereof and located on the housing long portion, wherein the first connecting circuit layer has a plurality of first conductive lines, and the first conductive lines being extended to the housing bottom for connecting the main conductive lines of the main circuit layer;
a second connecting circuit layer, being attached to the first thermally conductive insulating layer by the inner surface thereof and located on the housing short portion, wherein the second connecting circuit layer has a plurality of second conductive lines, and the second conductive lines being extended to the housing bottom for connecting the main conductive lines of the main circuit layer;
a plurality of LED chips, being disposed on the main circuit layer and located on the metal pads, moreover, the LED chips respectively passing through the second holes and the first holes by a light-emitting surface thereof, so that each of the LED chips enter the housing and being snugly covered by the inner walls of the first holes, respectively;
a reflector, being opposite to the LED chips and disposed in the housing, the reflector having a plurality of third holes for facilitating each of the light-emitting surfaces of the LED chips to pass through; and
a light guide plate, being disposed in the reflector for receiving the light emitted from the third holes;
wherein when the LED chips emit the light, the heat produced by each of the surfaces of the LED chips can be rapidly conducted to the housing via the inner walls of the first holes, and then the heat may be dissipated through the housing.

10. The backlight module with connecting circuits of claim 9, further comprising a bottom reflector, which is disposed on the bottom of the light guide plate for preventing from the light leakage.

11. The backlight module with connecting circuits of claim 9, wherein LED chips are welded on the metal pads by way of a first-time welding process, and the first connecting circuit layer and the second connecting circuit layer being connected to the main circuit layer through a second-time welding process.

12. The backlight module with connecting circuits of claim 9, wherein manufacturing material of the housing is selected from the group consisting of: metal, high reflectivity polyester film, plastic, and fiberglass.

13. The backlight module with connecting circuits of claim 12, wherein when the housing is made by the metal material with thermal conductivity, the housing long portion is further formed a housing tassel on the end thereof.

14. The backlight module with connecting circuits of claim 9, wherein the manufacturing material of the substrate is selected from the group consisting of: metal and fiber glass.

15. The backlight module with connecting circuits of claim 9, wherein the end of the reflector is further formed a reflector tassel.

16. The backlight module with connecting circuits of claim 9, wherein a heat radiative material can be further coated on the outer surface of the first connecting circuit layer and the second connecting circuit layer after the first connecting circuit layer and the second connecting circuit layer are disposed on the outer surface of the housing long portion and the housing short portion.

17. A backlight module with connecting circuits, comprising:
an extrusion housing, having at least one bottom portion and a bearing portion formed on the bottom portion;
a housing, being disposed on the bearing portion of the extrusion housing and having at least one housing bottom, at least one housing long portion and at least one housing short portion, moreover, a plurality of first holes being formed on the housing bottom;
a first thermally conductive insulating layer, being disposed on the outer surface of the housing for covering the housing bottom, the housing long portion and the housing short portion, the first thermally conductive insulating layer having a plurality of second holes formed on the side thereof opposite to the housing bottom;
a substrate;
a main circuit layer, being disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, being attached to the first thermally conductive insulating layer by the inner surface thereof and located on the housing long portion, wherein the first connecting circuit layer has a plurality of first conductive lines, and the first conductive lines being extended to the housing bottom for connecting the main conductive lines of the main circuit layer;
a second connecting circuit layer, being attached to the first thermally conductive insulating layer by the inner surface thereof and located on the housing short portion, wherein the second connecting circuit layer has a plurality of second conductive lines, and the second conductive lines being extended to the housing bottom for connecting the main conductive lines of the main circuit layer;
a plurality of LED chips, being disposed on the main circuit layer and located on the metal pads, moreover, the LED chips respectively passing through the second holes and the first holes by a light-emitting surface thereof, so that the LED chips entering the housing;
a reflector, being opposite to the LED chips and disposed in the housing, the reflector having a plurality of third holes for facilitating each of the light-emitting surfaces of the LED chips to pass through; and
a light guide plate, being disposed in the reflector for receiving the light emitted from the third holes.

18. The backlight module with connecting circuits of claim 17, further comprising:
a bottom reflector, being disposed on the bottom of the light guide plate for preventing from the light leakage;
at least one first shaped thermal conductive layer, being disposed in the housing and having a first bottom, a first side portion and a second side portion, wherein when the first shaped thermal conductive layer is disposed in the housing, the first shaped thermal conductive layer being attached to the housing bottom by the first bottom thereof, and the first side portion and the second side portion of the first shaped thermal conductive layer being attached to each of one side surfaces of the LED chips and the housing short portion; and
at least one second shaped thermal conductive layer, being opposite to the first shaped thermal conductive layer and disposed in the housing and having a second bottom, a third side portion and a fourth side portion, wherein when the first shaped thermal conductive layer is disposed in the housing, the second shaped thermal conductive layer being attached to the housing bottom by the second bottom thereof, and the third side portion and the fourth side portion of the second shaped thermal conductive layer being attached to each of another one side surfaces of the LED chips and the housing long portion;
wherein when the LED chips emit the light, the heat produced by each of the surfaces of the LED chips can be rapidly conducted to the housing via the first shaped thermal conductive layer and the second shaped thermal conductive layer, and then the heat may be dissipated through the housing.

19. The backlight module with connecting circuits of claim 17, wherein LED chips are welded on the metal pads by way of a first-time welding process, and the first connecting circuit layer and the second connecting circuit layer being connected to the main circuit layer through a second-time welding process.

20. The backlight module with connecting circuits of claim 17, wherein manufacturing material of the extrusion housing is selected from the group consisting of: copper, aluminum, galvanized steel sheet, and hot-dip galvanized steel sheet.

21. The backlight module with connecting circuits of claim 17, wherein manufacturing material of the housing is selected from the group consisting of: metal, high reflectivity polyester film, plastic, and fiberglass.

22. The backlight module with connecting circuits of claim 21, wherein when the housing is made by the metal material with thermal conductivity, the housing long portion is further formed a housing tassel on the end thereof, and the housing tassel may be attached to the inner surface of the bottom portion of the extrusion housing.

23. The backlight module with connecting circuits of claim 17, wherein the manufacturing material of the substrate is selected from the group consisting of: metal and fiber glass.

24. The backlight module with connecting circuits of claim 17, wherein the end of the reflector is further formed a reflector tassel.

25. The backlight module with connecting circuits of claim 17, wherein a heat radiative material can be further coated on the outer surface of the first connecting circuit layer and the second connecting circuit layer after the first connecting circuit layer and the second connecting circuit layer are disposed on the outer surface of the housing long portion and the housing short portion.

26. The backlight module with connecting circuits of claim 17, wherein the substrate further comprises a combination device.

27. The backlight module with connecting circuits of claim 17, wherein at least one heat-conductive foam is disposed on the outer surface of the bottom portion of the extrusion housing.

28. A backlight module with connecting circuits, comprising:
an extrusion housing, having at least one bottom portion and a bearing portion formed on the bottom portion;
a housing, being disposed on the bearing portion of the extrusion housing and having at least one housing bottom, at least one housing long portion and at least one housing short portion, moreover, a plurality of first holes being formed on the housing bottom and the plurality of first holes sinking from the outer surface to the inner surface of the housing bottom;
a first thermally conductive insulating layer, being disposed on the outer surface of the housing for covering the housing bottom, the housing long portion and the housing short portion, the first thermally conductive insulating layer having a plurality of second holes formed on the side thereof opposite to the housing bottom;
a substrate;
a main circuit layer, being disposed on the substrate through a second thermally conductive insulating layer and having a plurality of metal pads and a plurality of main conductive lines connecting to the metal pads, wherein the main circuit layer and the substrate are attached to the first thermally conductive insulating layer and located on the outer surface of housing bottom;
a first connecting circuit layer, being attached to the first thermally conductive insulating layer by the inner surface thereof and located on the housing long portion, wherein the first connecting circuit layer has a plurality of first conductive lines, and the first conductive lines being extended to the housing bottom for connecting the main conductive lines of the main circuit layer;
a second connecting circuit layer, being attached to the first thermally conductive insulating layer by the inner surface thereof and located on the housing short portion, wherein the second connecting circuit layer has a plurality of second conductive lines, and the second conductive lines being extended to the housing bottom for connecting the main conductive lines of the main circuit layer;
a plurality of LED chips, being disposed on the main circuit layer and located on the metal pads, moreover, the LED chips respectively passing through the second holes and the first holes by a light-emitting surface thereof, so that each of the LED chips enter the housing and being snugly covered by the inner walls of the first holes, respectively;
a reflector, being opposite to the LED chips and disposed in the housing, the reflector having a plurality of third holes for facilitating each of the light-emitting surfaces of the LED chips to pass through; and
a light guide plate, being disposed in the reflector for receiving the light emitted from the third holes;
wherein when the LED chips emit the light, the heat produced by each of the surfaces of the LED chips can be rapidly conducted to the housing via the inner walls of the first holes, and then the heat may be dissipated through the housing.

29. The backlight module with connecting circuits of claim 28, further comprising a bottom reflector, which is disposed on the bottom of the light guide plate for preventing from the light leakage.

30. The backlight module with connecting circuits of claim 28, wherein LED chips are welded on the metal pads by way of a first-time welding process, and the first connecting circuit layer and the second connecting circuit layer being connected to the main circuit layer through a second-time welding process.

31. The backlight module with connecting circuits of claim 28, wherein manufacturing material of the housing is selected from the group consisting of: metal, high reflectivity polyester film, plastic, and fiberglass.

32. The backlight module with connecting circuits of claim 31, wherein when the housing is made by the metal material with thermal conductivity, the housing long portion is further formed a housing tassel on the end thereof.

33. The backlight module with connecting circuits of claim 28, wherein the manufacturing material of the substrate is selected from the group consisting of: metal and fiber glass.

34. The backlight module with connecting circuits of claim 28, wherein the end of the reflector is further formed a reflector tassel.

35. The backlight module with connecting circuits of claim 28, wherein a heat radiative material can be further coated on the outer surface of the first connecting circuit layer and the second connecting circuit layer after the first connecting circuit layer and the second connecting circuit layer are disposed on the outer surface of the housing long portion and the housing short portion.

36. The backlight module with connecting circuits of claim 28, wherein the substrate further comprises a combination device.

37. The backlight module with connecting circuits of claim 28, wherein at least one heat-conductive foam is disposed on the outer surface of the bottom portion of the extrusion housing.
